(19) United States
(12) Patent Application Publication
(10) Pub. No.: US 2012/0035986 A1
(43) Pub. Date: Feb. 9, 2012

(54) SYSTEMS AND METHODS FOR THE SKILL ACQUISITION AND DEMONSTRATION OF SKILL

(76) Inventor: ANDRES JIMENEZ, Zionsville, IN (US)

(21) Appl. No.: 12/850,810

(22) Filed: Aug. 5, 2010

(51) Int. Cl. G06Q 10/00; G09B 7/00

(52) U.S. Cl. 705/7.42; 434/362

(57) ABSTRACT

A system for the management of skill acquisition and demonstration of skill mastery, in one example embodiment, comprises an interface between a learner and a skill acquisition and demonstration of skill mastery system, a display module to display, via the interface, one or more skills to be acquired by the learner, a training module to provide training material to the learner, a testing module to test acquisition of the one or more skills by the learner, a status module to determine, based on the testing, a status indicative of the acquisition of and thus demonstration of mastery of the one or more skills by the learner, a statistics module to collect statistics associated with the acquisition of and thus demonstration of mastery of the one or more skills, and a report module to report the acquisition of and thus demonstration of mastery of the one or more skills. The training material may include multimedia. The testing module may provide questions related to the multimedia. Correctly answering the questions may result in the automatic change of status associated with the one or more skills. The system may also comprise a statistics module to provide statistics accessible by clicking on a point in a graph associated with the skill acquisition and demonstration of skill mastery. The demonstration of skill mastery may be provided by a support staff while assessing the mastery of a specific skill. The system may operate in substantially real time.

### FIELD

The present disclosure relates generally to data processing. More specifically, the present disclosure relates to systems and methods for skill acquisition and the demonstration of skill mastery.

### BACKGROUND

An organization implementing a new software system may want to ensure that its personnel are properly trained on how to use the new software system and have immediate onsite support while operating the system for the first time during an implementation. In case of an enterprise level system, the software developer may also be responsible for support personnel on operating the system. The support program can be operated by the software developer or outsourced to a third party specializing in such services. Regardless of who operates the support program, it typically involves bringing support staff onsite to provide support to users of the new software system if they encounter any difficulties with the system. The support staff can also take advantage of opportunities to provide additional relevant training to the learners by targeting the learners' apparent skill deficiencies.

There are multiple challenges to the above-mentioned approach. The support program operator often lacks the number of staff members needed to provide adequate support for a large organization that may be undergoing several implementations of the new software system at the same time. Additionally, there is often no consistency in the support provided (e.g., explanations and rationalization for specific recommendations regarding specific skills relevant to the new software program), and differences in what may be taught by different members of the support staff regarding specific skills relevant to the new software program categorized by specific user levels (e.g., novice, intermediate and advanced). Thus, for example, different staff members may teach in different ways, or recommend different solutions to accomplish the same objective with the new software system. As a result, in an organization with multiple departments, personnel may acquire different or conflicting skills and become confused. Because this level of support/training services is often provided by a third party, the software developer who has the expertise may not have onsite presence and may not personally observe the process.

In addition, different support personnel may have varying levels of mastery with the specific skills, and occasions may arise where a less experienced support staff person covers for an absent support staff person, and this could introduce additional confusion to learners if guidance provided by the substitute support staff person is not consistent with recommendations from the primary support staff. Therefore, the software developer or support management may have no good way of knowing the efficiency of its support program or the training program prior to the implementation of the new software system. It may be difficult to judge the effectiveness of the support program until the support staff leaves, or until those who were learning to use the new software system start using it. Finally, in a typical support program, there may be no good way of tracking and managing the impact of previous training initiatives, and its ability to prepare personnel for using the system and gaining knowledge during onsite support at implementation.

### BRIEF DESCRIPTION OF DRAWINGS

Example embodiments are illustrated by way of example and not limitation in the figures of the accompanying drawings, in which like references indicate similar elements and in which:

FIG. 1 is a block diagram showing a sample network environment within which systems and methods for the skill acquisition and demonstration of skill mastery are implemented, in accordance with an example embodiment;

FIG. 2 is a block diagram showing a skill acquisition and demonstration of skill mastery system, in accordance with an example embodiment;

FIG. 3 is a flow chart showing a method for the management of skill acquisition and demonstration of skill mastery, in accordance with an example embodiment;

FIG. 4 is a block diagram showing a skill acquisition and demonstration of skill mastery environment, in accordance with an example embodiment;

FIG. 5 is a block diagram showing a user interface environment, in accordance with an example embodiment;

FIG. 6 is a block diagram showing a method for updating skill status, in accordance with an example embodiment;

FIG. 7 is a graph showing skill acquisition and demonstration of skill mastery over time for a group of learners, in accordance with an example embodiment;

FIG. 8 is a graph showing frustration level over time for a learner, in accordance with an example embodiment;

FIG. 9 is a graph showing frustration level over time for a learner and a comment associated with a graph point, in accordance with an example embodiment;

FIG. 10 is a graph showing daily stress level for a learner, in accordance with an example embodiment;

FIG. 11 is a frustration scale used to select a frustration level for a learner, in accordance with an example embodiment; and

FIG. 12 is a diagrammatic representation of an example machine in the form of a computer system within which a set of instructions for causing the machine to perform any one or more of the methodologies discussed herein is executed.

### DETAILED DESCRIPTION

The following detailed description includes references to the accompanying drawings, which form a part of the detailed description. The drawings show illustrations in accordance with example embodiments. These example embodiments, which are also referred to herein as “examples,” are described in enough detail to enable those skilled in the art to practice the present subject matter. The embodiments can be combined, and other embodiments can be formed by introducing structural or logical changes without departing from the scope of what is claimed. The following detailed description is, therefore, not to be taken in a limiting sense, and the scope is defined by the appended claims and their equivalents.

In this document, the terms “a” or “an” are used, as is common in patent documents, to include one or more than one. In this document, the term “or” is used to refer to a nonexclusive “or,” such that “A or B” includes “A but not B,” “B but not A,” and “A and B,” unless otherwise indicated. Furthermore, all publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

Systems and methods for skill acquisition and the demonstration of skill mastery may, in some example embodiments, enable parties involved in the implementation of a new software system to keep track of the impact of the previous learning process (e.g., pre-implementation training) on skill acquisition and demonstration of skill mastery from the beginning of the implementation in a uniform and traceable manner.

According to one example embodiment, a system developer may keep track of how the support staff members conduct their support process to ensure that there is consistency in their guidance, recommendation, and teachings. An organization adopting the new software system may benefit by tracking the process of skill acquisition and the demonstration of skill mastery and verifying that the core skills for specific proficiency levels (e.g., novice, intermediate and advanced) have been acquired before the support staff leaves. The personnel of the organization may benefit by knowing which parts of the system they need to learn, be empowered to learn the appropriate parts on their own, and perform automated checks without need for supervision from the support staff.

In some example embodiments, systems and methods for managing skill acquisition and demonstration of skill mastery may provide a central database for each learner that is updated in real time (e.g.,<1 minute refresh). Furthermore, the learning process may be made uniform by providing a list of skills needed in order to learn the system at a predetermined proficiency level. Each proficiency level (e.g., novice, intermediate, and advanced) can be achieved by acquiring the corresponding set of skills. A single skill acquisition and demonstration of skill mastery system may be utilized across a plurality of organizations, departments, and sites.

Systems and methods for the skill acquisition and demonstration of skill mastery are not limited to training personnel and may help with supporting learners who are users of a new software system being implemented. Systems disclosed herein may provide management/reporting based on the assessment of skill mastery that will drive real time reporting to help the organization's management guide optimization of implementation overtime based on objective data. Furthermore, the system may guide the support staff in the incorporation of relevant skill training that targets a learner's apparent skill deficiencies, provides a self-directed means for learners to assess their specific proficiency level related to the mastery of skills, and then provides learners with the opportunity to acquire new skills and/or demonstrate mastery of unassessed skills.

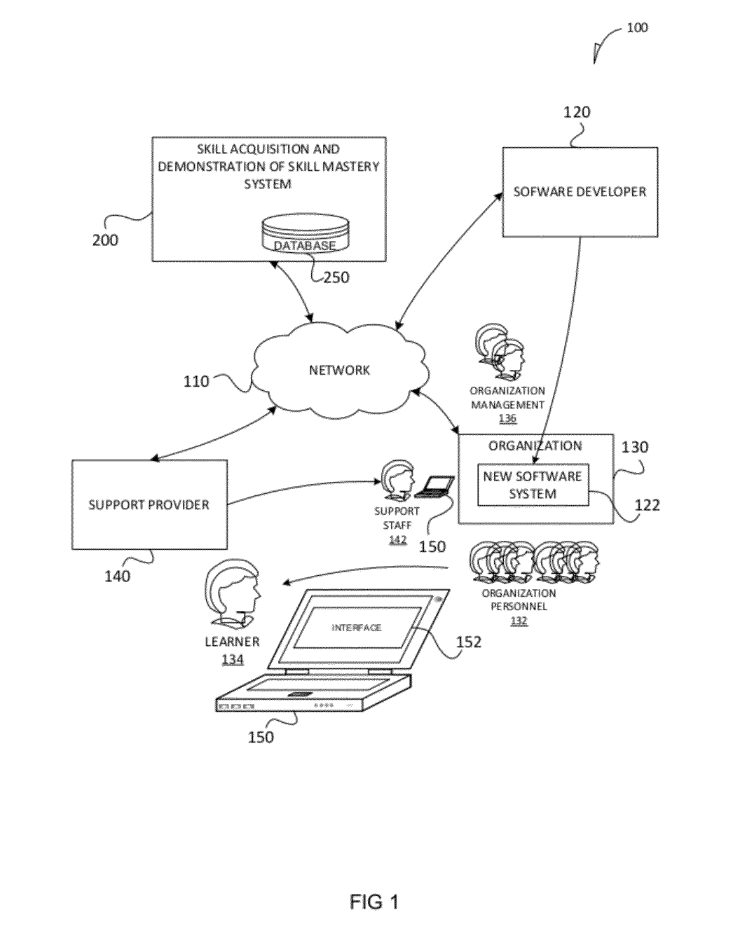

FIG. 1 is a block diagram showing a network environment 100 within which systems and methods for the skill acquisition and demonstration of skill mastery are implemented, in accordance with an example embodiment. As shown in FIG. 1, the sample network environment 100 can comprise a network 110, a software developer 120, an organization 130, a support provider 140, support staff 142, one or more user devices 150, and a skill acquisition and demonstration of skill mastery system 200.

The network 110 may be utilized to facilitate the real time exchange of data between various components of the network environment 100. The network 110, in one example embodiment, is a global system of interconnected computer networks (e.g., the Internet) that use the standard Internet Protocol Suite (TCP/IP) to serve users worldwide. The network 110 may include a network of networks that consists of private, public, academic, business, and government networks of local to global scope that are linked by a broad array of satellite, wireless, electronic, and optical networking technologies. The network 110 may carry a vast array of information resources and services, including the inter-linked hypertext documents of the World Wide Web (WWW) and the infrastructure to support electronic mail (email). The network 110 may provide a free flow of information and therefore it is inherently an insecure channel for exchanging information. Different methods may be used to protect the transfer of data over the network 110. This may include encryption, in which data is transformed and a decryption key is generated for the receiver of the data.

The software developer 120 may develop and provide a new software system 122 to the organization 130. It will be appreciated that the new software system 122 may be provided by a software distributor (not shown) instead of coming directly from the software developer 120. The software developer 120 may be concerned with all facets of the new software system 122, including its usability by organization personnel 132.

The organization 130 may be deploying the new software system 122 across a plurality of its departments. In some example embodiments, the organization 130 is a health care organization, the organization personnel 132 are physicians and the new software system 122 is an Electronic Health Record (EHR) system. Using the EHR system, physicians, or other medical personnel can enter patient data electronically. The data can include a patient's medical history and allergies. Using the EHR, a doctor can evaluate the patient's condition and enter a diagnosis, write prescriptions, and order further laboratory tests. Instead of having to review paper records, a doctor can review a patient's history online. Because the EHR system may be expensive and important to the successful operation of a health care organization, the medical personnel need to learn to utilize the system to its full potential. Therefore, support and training is one of the most important components of an EHR implementation. It will be appreciated, however, that the organization 130 is not limited to a health care organization.

The organization 130 may include an organization management 136. The organization management 136 may be responsible for the decision to install the new software system 122 and, accordingly, may be interested in following the implementation process and understanding the impact of training and support on the eventual use of the system by the organization personnel 132 across the entire organization 130. The organization 130 may be defined in the skill acquisition and demonstration of skill mastery system 200 at the commencement of the support process. A member of the support staff 142 may utilize a user interface 152 to define the organization 130 in the beginning of the support process.

Once the organization 130 is defined in the skill acquisition and demonstration of skill mastery system 200, the support staff 142 may utilize the user device 150 to present to the organization personnel 132 as a group or to a single learner 134, a list of skills, categorized by specific proficiency levels, that need to be acquired in order to become proficient users of the new software system 122. The support staff 142 may utilize a spreadsheet associated with the learners 134. The spreadsheet may list various skills related to the new software system 122. As mastery of a specific skill is demonstrated by the learner 134 while using the new software system 122 during implementation, the support staff 142 may check off the skill by changing the associated status. Thus, as the support staff 142 checks skills off the list, the status of the skill may change. The change in status may be indicated by a changed color (e.g. from yellow to green), via shapes (e.g. un-checked box to a checked box), or with text (e.g. “no” to “yes”). In addition to checking off skills, the support staff 142 may collect some additional variables. In case of a health care provider (e.g. a hospital), the variables may include, for example, the number of patients a doctor saw on a particular day, how long it took for the doctor to complete a certain note, or how long, on average, the doctor spent with a patient.

The status of a specific skill may be listed as Yes/No, as well as “NA” for Not Applicable on a skill that may not be relevant for the specific learner because of their specialty (e.g. use of a dosage calculator commonly used by pediatricians when prescribing antibiotics but not commonly used in adult primary care). If a specific skill is not applicable for the learner 134, then it can be suppressed, so that in the suppressed view in the support staff's 142 user interface of the skill acquisition and demonstration of mastery software, the support staff 142 may only see the skills that are not suppressed, thus making it easier to browse the list and change status on new skills that the learner demonstrates mastery of, and make it easier to browse skills whose mastery have yet to be assessed and thereby prompt even more focused opportunistic training by the support staff 142 to the learner 142.

Once the additional variables are entered, the learner 134 may have his own view of the system and can see what skills/concepts they know and have demonstrated mastery of and understand and what he or she still needs to know and understand and/or demonstrate mastery of for their specific proficiency level (e.g., novice, intermediate and advanced). Thus, the learner 134 may go online using his personal user device 150 to view which skills they have mastered and which they have not, and thus understand which additional skills they should acquire.

The learner 134 may click on a skill he would like to acquire and/or demonstrate mastery of and then view related training material (e.g., a brief video). Thereafter, the learner 134 may take a test. In some example embodiments, the status of the skill may automatically change to indicate that the skill was acquired if the results of the test are positive.

Thus, instead of using support staff 142 to assess a learner's 134 mastery of specific skills while onsite supporting the implementation and use of the new software system, the learner 134 may review the training material (e.g., watch a video) online and take a test (e.g., multiple choice questions) to demonstrate skill acquisition and mastery. Various parties having a stake in the skill acquisition and demonstration of skill mastery process may review the progress of an individual learner or group of learners. For example, the organization management 136 may login via the interface 152 and view a list of reports for the organization 130. Each organization or sub group may be associated with a brief summary, including the number of personnel 132 and when the training process commenced.

The skill acquisition and demonstration of skill mastery system 200 may provide other ways to assess the proficiency of the learner 134 by providing the support staff 142 with the ability to activate a screen view enabling the support staff 142 to see the learner's 134 computer screen, for example, when the learner 134 is a physician and is in the office seeing a patient. This approach allows remote assessing of the mastery of skills while viewing the leaner's 134 screen and updating the check off list. In the case of physician seeing a patient (and in other situations), the support staff 142 may not go into the room to personally assess the mastery of skills. Using this approach, the support staff is able to assess how the learner 134 (e.g., a physician) uses the new software system 122 in a real-life situation. In addition, the support staff 142, once they have been approved by the learner 134, may control when the learner 134 streams his screen view to better control overall network bandwidth demands.

The organization management 136 may obtain a real time skills acquisition report for the organization 130 and review, for a specific day, the number of skills that were checked off for a specific learner, as well as an average number of skills for all learners in the organization 130. The skill acquisition and demonstration of skill mastery system 200 may support different user types such as the support staff 142, the learner 134, and the organization management 136. Once a sufficient amount of data is accumulated, an operator of the skill acquisition and demonstration of skill mastery system 200 may set up a way to remotely review the progress of the personnel 132.

The skill acquisition and demonstration of skill mastery system 200 may be fully automated to present, collect and store data related to the learner 134 based on where the learner 134 is in the support/training/implementation process. A dash board of the progress may be presented to the organization management 136. The support provider 140 may provide support staff 142 who may utilize the user device 150 to click on a skill, and pop open a new webpage containing a video clip describing the skill to ensure they accurately understand what is considered mastery for a specific skill. This webpage may contain a “Continue” button at the bottom, which may take the support staff 142 to the related multiple choice questions that the learner 134 would see when testing on a specific skill. For the learner 134, the interface 152 may differ from the interface that the support staff 142 would see in that the support staff may only view the skills in the read-only mode. Thus, the support staff may take the test but the status associated with the corresponding skill or skills will not change as a result of answering the multiple choice question correctly.

This view presented to the support staff 142 may prominently display the name of the learner 134 to ensure that any support staff 142 training different learners does not accidently enter data into the wrong learner's skills list. If the support staff 142 is idle for a predetermined period of time (e.g., 5 minutes), the next time they try to enter data they may receive a prompt to verify that they are assessing the appropriate learner. The prompt may list the learner 134 whose skills list is about to be updated. Selecting the button associated with the learner 134 may allow entry of the previous selection that activated the prompt. If the support staff 142 selected the wrong learner's link, it may not register the assessment and will then ask the support staff 142 to select from a list of personnel 132 from the organization 130.

Multiple support staff may assess the personnel 132 and identify skill acquisition and demonstration of skill mastery. The personnel may alternate on different days or even within different hours of the same day. The skill acquisition and demonstration of skill mastery of the personnel is consistently tracked, stored and displayed in substantially real time (e.g.,<1 min), ensuring that multiple support staff have a snap shot available of the current personnel's mastery of specific skills categorized to specific proficiency levels, and can focus primarily on apparent skill deficiencies based on the learner's expected proficiency level when providing support or opportunistic supplemental training on skills. For example, a learner snap shot based on the mastery of skills over time may be shown. Furthermore, volume tracking (e.g., time to complete a task within the new software system related to a specific skill or daily patient load) can be viewed. A status can be sent to the skill acquisition and demonstration of skill mastery system 200 for review. Errors may be reported to an appropriate person on the team. The training materials may be combined with frequently asked questions and feedback. Some type of check and balance may be performed to make sure that the data is being entered into the correct learner's list. For example, if there is no activity for a time period, the support staff 142 may be prompted to supply the name of learner 134. Undo functionality may be implemented.

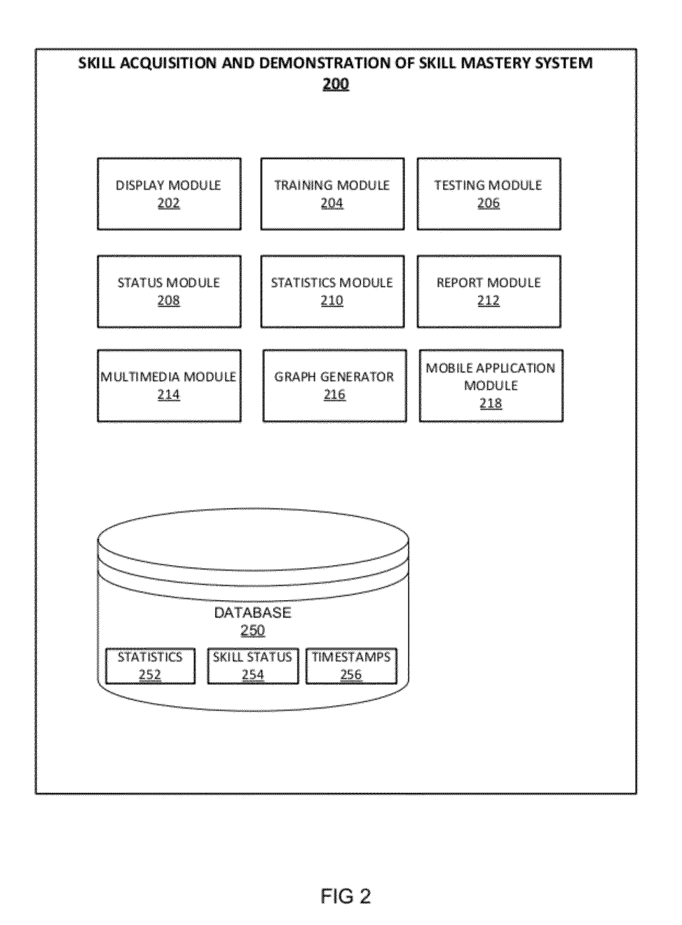

The skill acquisition and demonstration of skill mastery system 200 may allow logging into several learners' lists at the same time and the ability to toggle between their records and provide the means to capture comments. Whenever a skill is checked off, a time stamp can be created. The skill acquisition and demonstration of skill mastery system 200 may provide site specific skills, allow users to collapse and browse specific skills, filter skills by user level, and search specific skills to make entry easier. An admin panel can be provided to make it easier to build and submit a skill list, along with attaching videos and multiple choice questions to each skill. The skill acquisition and demonstration of skill mastery system 200 may also comprise a database 250 and is described in more detail below with reference to FIG. 2.

FIG. 2 is block diagram showing the skill acquisition and demonstration of skill mastery system 200, in accordance with an example embodiment. As shown in FIG. 2, the skill acquisition and demonstration of skill mastery system 200 may comprise a display module 202, a training module 204, a testing module 206, a status module 208, a statistics module 210, a report module 212, a multimedia module 214, a graph generator 216, and a mobile application module 218. The skill acquisition and demonstration of skill mastery system 200 may further comprise the database 250, which in turn, may comprise statistics 252, skill status 254, and timestamps 256. The database 250 may facilitate real time data sharing between all components of the network environment 100 shown above with reference to FIG. 1.

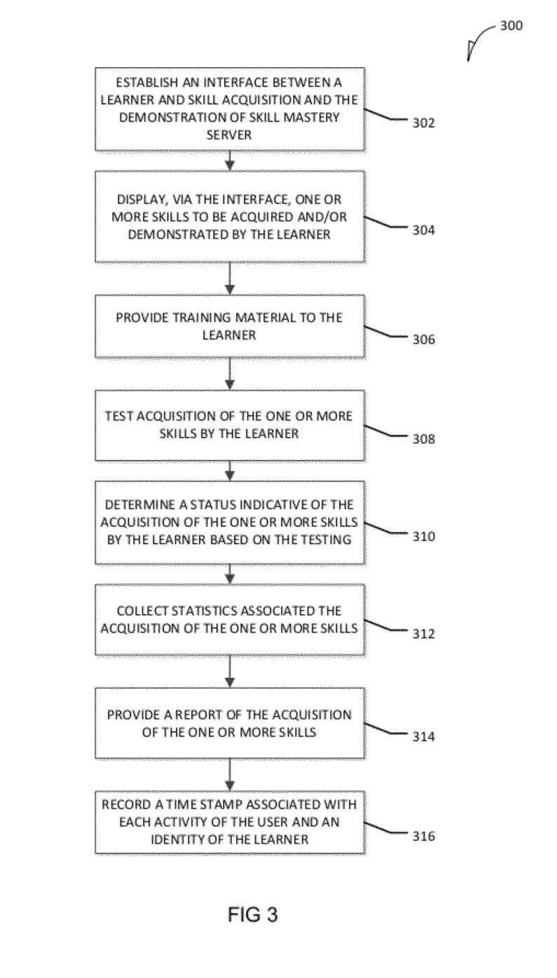

The display module 202 may facilitate displaying of information via the interface 152. The interface 152 may allow support staff 142 to login, select a specific learner listed by organization, and then see a list of the skills the learner has already demonstrated mastery of while using the new software system 122 correctly. Sample operations of the foregoing modules are described in more detail with reference to the method 300 of FIG. 3 below.

FIG. 3 is a flow chart showing a method for skill acquisition and demonstration of skill mastery system 200, in accordance with an example embodiment. The method 300 may be performed by processing logic that may comprise hardware (e.g., dedicated logic, programmable logic, microcode, etc.), software (such as that which is run on a general-purpose computer system or a dedicated machine), or a combination of both. In one example embodiment, the processing logic resides at the skill acquisition and demonstration of skill mastery system 200 illustrated in FIG. 2.

The method 300 may commence at operation 302 with the display module 202 establishing the interface 152 between a user (e.g., a support staff member, an organization manager, or a learner) and the skill acquisition and demonstration of skill mastery system 200. At operation 304, the skills to be acquired and mastered by the learner 134 while using the new software system 122 based on their specific proficiency level may be displayed via the interface 152. The skills may be predetermined based on a desired level of skill proficiency and demonstration of skill mastery and specific configuration of the new software system 122, which may vary within an organization depending on the need to accommodate sub-organization workflow variations.

The skills may be organized by the module of the new software system 122 (e.g. results module, charge module, orders module, task module) and may also be organized by the screen the learner 134 is currently viewing, since some skills may be associated with tasks accessible from within specific screens (e.g. in case of an EHR, a prescribing screen and note documentation screens). If the support staff 142 witnesses mastery of a specific skill that a support staff person knows is on the list but cannot locate, he may search the complete list of skills by keywords that are associated with that skill (e.g. search keywords “split prescription” for the skill of “knowing how to split a prescription between mail order and samples dispensed to the patient in the office”).

At operation 312, the statistics module 210 may facilitate gathering statistics associated with the acquisition of skill and demonstration of skill mastery. For example, the statistics may include a frustration level of the learner, a stress level of the learner, and notes associated with using the new software system 122 during implementation when the personnel 132 are attempting to accomplish daily tasks while demonstrating mastery of skills learned and accomplishing those specific tasks. The frustration level, job load (e.g., patients per day), and comments variables may be added by the support staff 142. In the interface 152, the frustration level may be entered from a drop down menu of choices (e.g., 0-10). Comments may be provided in a free text entry field as subjective observations (e.g., physician became upset when they realized their charges were not entered correctly). The job load per day may be entered in a free text entry field by the support staff 142.

In some example embodiments, the learner 134 may be allowed to select the frustration level on a visual scale. The training material may be provided by the training module 204 at operation 306. The training material may include multimedia. The learner 134 may acquire skills by watching the multimedia. At operation 308, the testing module 206 may facilitate testing of the skills (and mastery demonstration) the learner acquired from watching the multimedia. Correctly answering a predetermined number of questions may result in an automatic change of the status associated with the skills. The report module 212 may generate various reports for stakeholders. The reports may include a time period view, a group view, a number of skills acquired by a group of learners, a number of skills acquired by a specific learner, and graphs associated with the skill acquisition and demonstration of skill mastery. The statistics may be accessed by clicking on a point in a graph associated with a skill acquisition and demonstration of skill mastery.

At operation 310, the status module 208 may determine a status indicative of the acquisition of the skills by the learner 134 based on the testing facilitated by the testing module 206. At operation 312, the report statistics module 210 may collect statistics associated with the acquisition of the skills and demonstration of mastery, and at operation 314, the report module 212 may provide a report of the acquisition of the skills and demonstration of skill mastery. The report may demonstrate the percentage of skills completed for a specific proficiency level and can be reviewed by the organization management 136. For example, if the learner 134 is placed into the intermediate proficiency level as defined by the organization 130 by demonstrating mastery of 10 specific skills, demonstration of mastery of 4 of the skills will display a 40% demonstration of mastery for the learner 134 at that specific proficiency level. Since demonstration of mastery for the novice proficiency may be needed for the next levels (e.g., intermediate and advanced), the same report can demonstrate percentage of mastery for different proficiency levels (e.g. 100% for novice, 20% for intermediate, 5% for advanced). This is helpful when skills being assessed are not part of the core skills needed for a specific proficiency level, or when users can demonstrate mastery of advanced as well as novice associated skills in any order. For instance, a user may demonstrate mastery of a few intermediate and advanced proficiency associated skills, before complete mastery of all of the core skills for the novice proficiency level. At operation 316 a time stamp associated with each activity of the user and an identity of the learner 134 may be created.

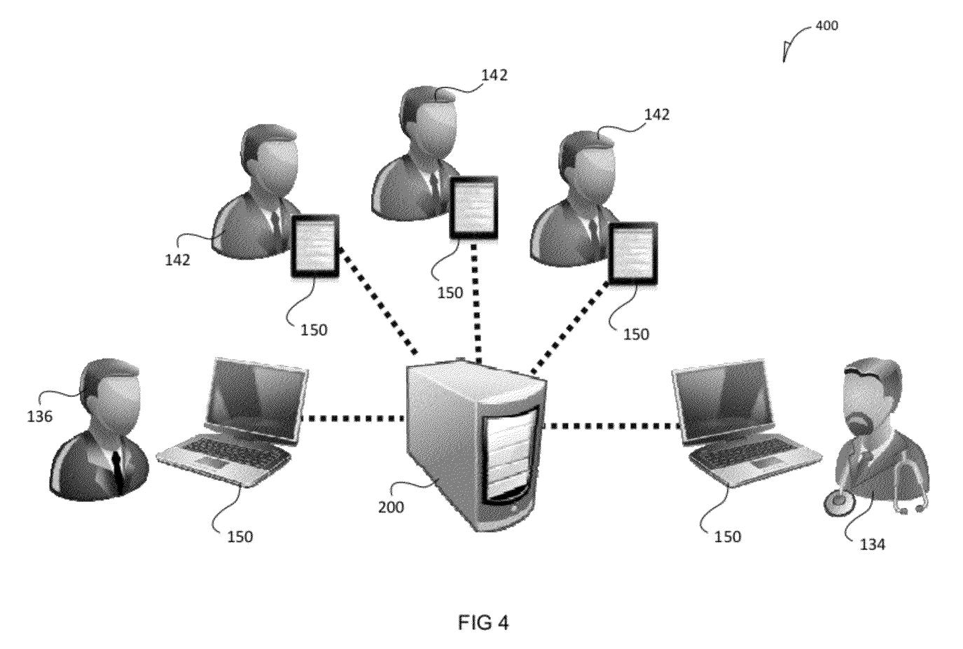

FIG. 4 is a block diagram showing a skill acquisition and demonstration of skill mastery environment 400, in accordance with an example embodiment. Every party is shown connected to the skill acquisition and demonstration of skill mastery system 200. The support staff 142 may be provided with data viewable in real time which includes acquisition of skills and demonstration of skills mastered by the learner 134 over time. The support staff 142 may ascertain which skills the learner 134 needs to acquire to advance their proficiency level in using the new software system 122. The learner 134 may either demonstrate mastery of skills learned during pre-implementation training or post implementation by previous support staff helping the learner 134, and the support staff 142 can assess the learner's 134 demonstration of skill mastery over time and current specific proficiency level.

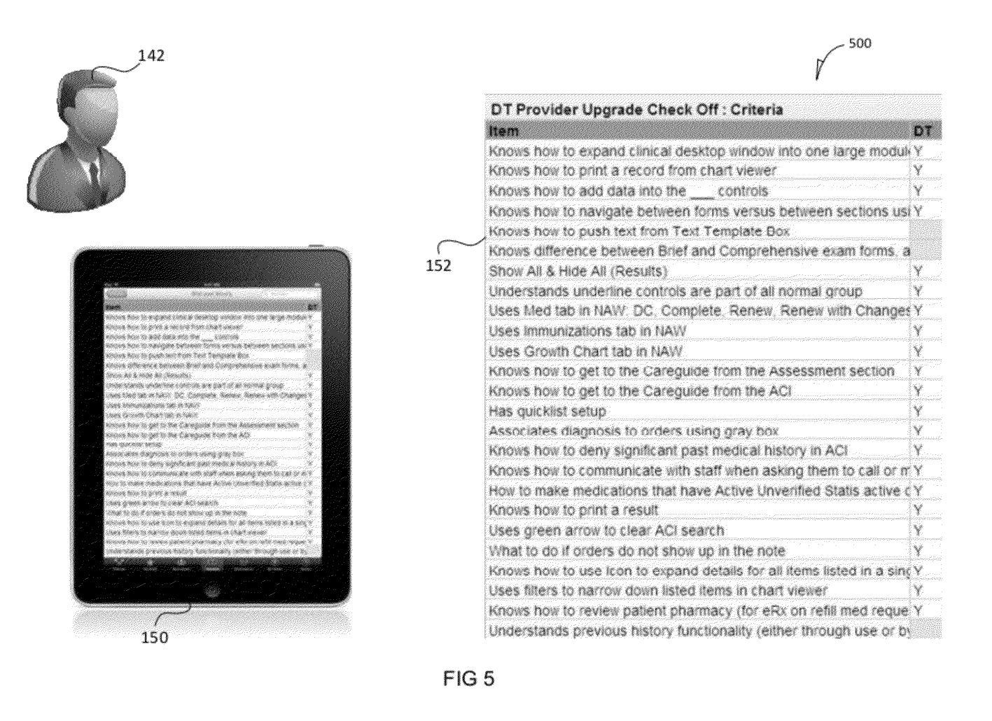

FIG. 5 is a block diagram showing user interface environment 500, in accordance with an example embodiment. The support staff 142 may be using a laptop to go through the list and check off skills when they witness the learner 134 demonstrating mastery by performing the skill appropriately while completing a specific task during their use of the new software system 122. If the skill is not checked off, it may stay yellow to alert the support staff 142 that mastery of the specific skill has yet to be demonstrated, and potentially prompt the support staff 142 to demonstrate mastery of this skill to the learner 134 as a supplemental learning opportunity with the learner 134 in substantially real time. One support staff member 142 can be substituted with another support staff member 142 and the second staff member 142 may immediately see where the first one left off because he may see what skills are pending mastery demonstration for the learner's specific proficiency level, and the data is captured and displayed across the database in substantially real time (e.g.,<1 minute refresh rates).

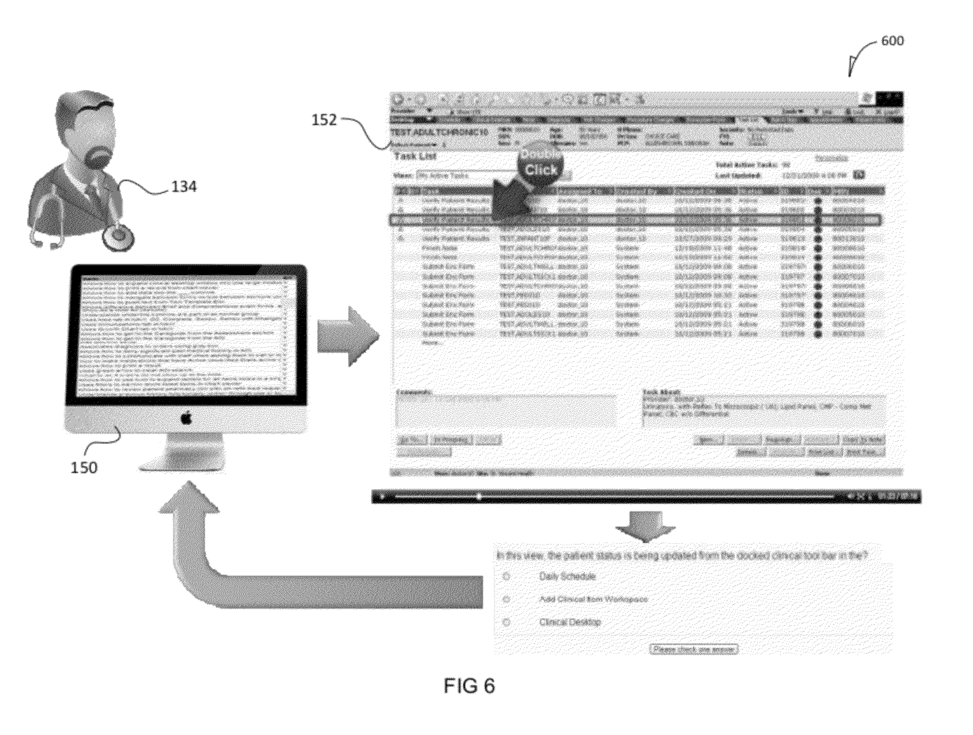

FIG. 6 is a block diagram showing a method 600 that may be utilized to update skill status, in accordance with an example embodiment. The interface 152 may be utilized by the learner 134 to demonstrate mastery of a specific skill that was not assessed by the support staff 142 providing support while the learner 134 was using the new software system 122. The learner 134 may see the list of skills they have already mastered. The learner 134 may also learn which skills he or she needs to acquire and/or demonstrate mastery of at their expected proficiency level and to become a more effective user of the new software system 122. The learner 134 may see a line highlighted in yellow that represents a skill that the mastery was not assessed by the support staff 142 during onsite support, and the learner 134 can launch a brief video and then take a multiple choice quiz, and his or her status may change from yellow to having a “yes,” thus registering demonstration of mastery of the specific skill. The system can time stamp this change in status, as well as recognize the mastery of this specific skill was accomplished via testing versus assessment by the support staff 142.

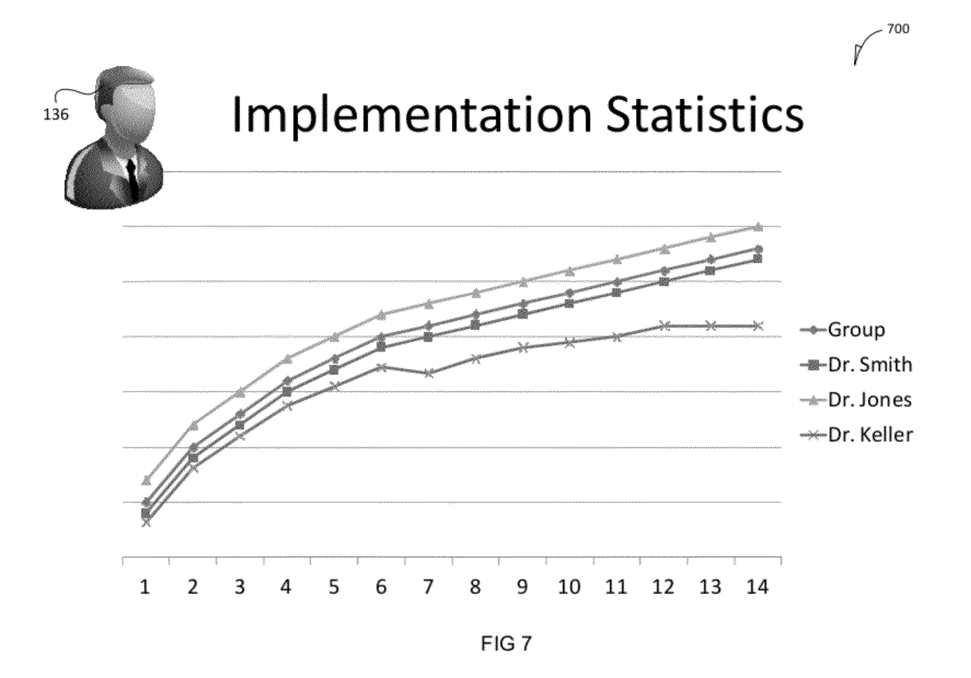

FIG. 7 is a graph 700 showing skill acquisition and demonstration of skill mastery over time for a group of learners, in accordance with an example embodiment. The organization management 136 may review the data concerning the demonstration of mastery of new skills over time. The organization management 136 may look at the group average and look at the individual users. As shown in FIG. 7, Dr. Jones, for example, is a good user because he is demonstrating mastery of new skills faster than the group average. Dr. Keller was doing well but on day 7 he fell behind at his rate of demonstrating mastery of new skills for his specific proficiency level and in relation to the entire group. The information may be displayed as a graph which, when a mouse is hovered over a specific data point in the graph, may display the actual value and additional links to other relevant variables such as daily patient volume, frustration level, and comments (or any other type of relevant variable).

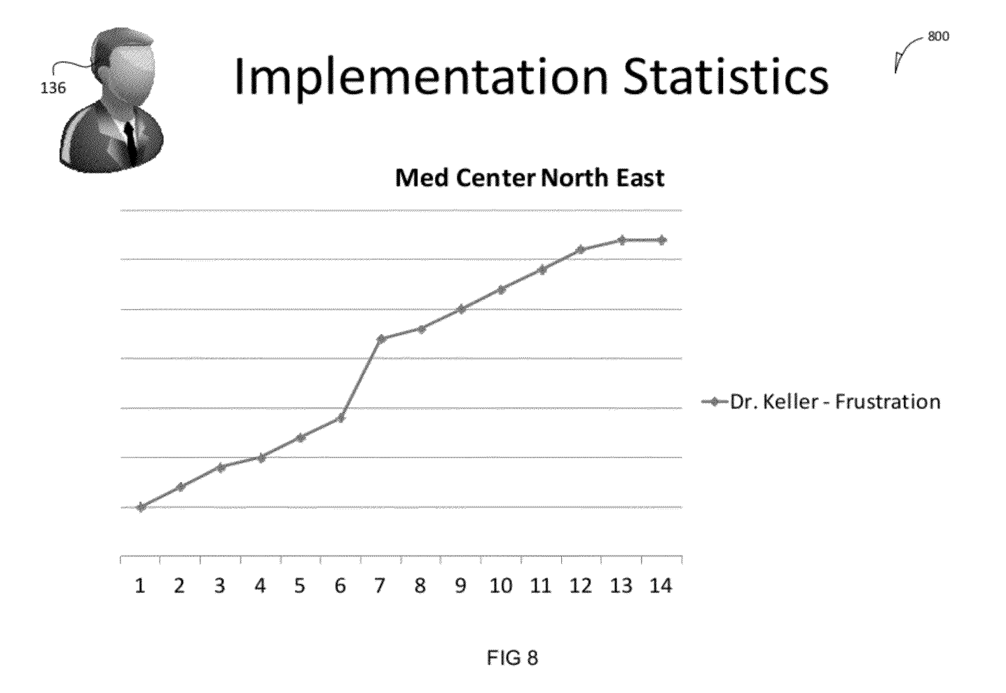

FIG. 8 is a graph 800 showing frustration level over time for the learner 134, in accordance with an example embodiment. When a data point is clicked, there may be a choice of daily patient volume, frustration level, and comments. The frustration level can indicate that Dr. Keller's frustration level jumped higher on day 7.

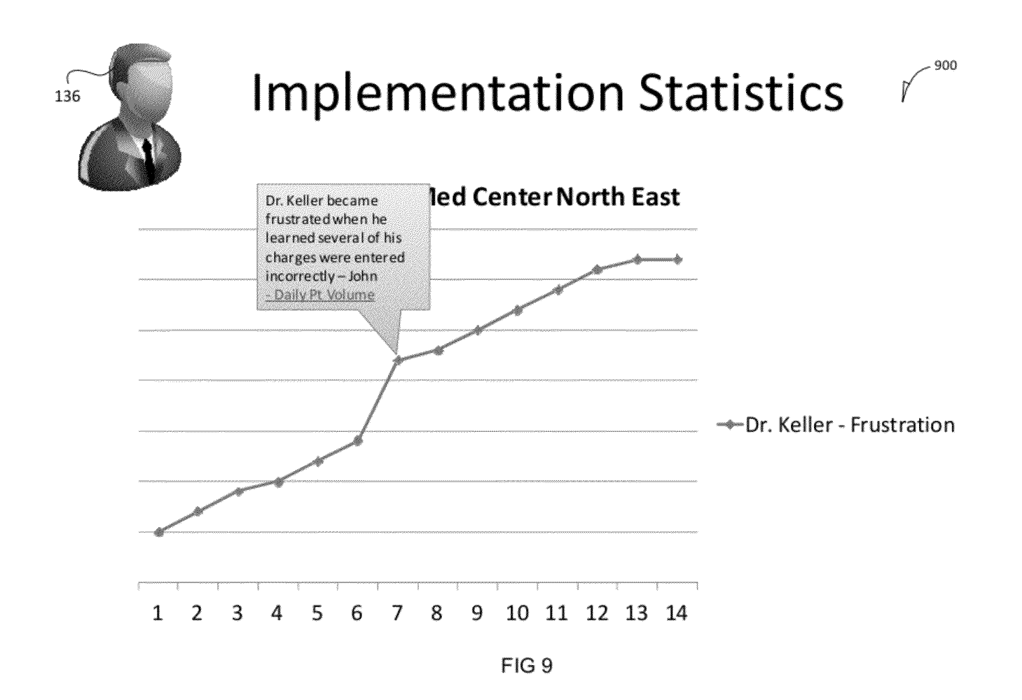

FIG. 9 is a graph 900 showing frustration level over time for a learner and a comment associated with a graph point, in accordance with an example embodiment. The graph point can be clicked on to find out why the frustration level increased. A note can appear saying that several of Dr. Keller charges were entered incorrectly on that date, reported by either Dr. Keller (as the learner 134), or by the support staff 142. Thus, clicking on a specific data point may open a window with links to additional reports for that organization (for example, frustration level, job load, comments, etc.). Over the entire period of support, the data points for skills plotted over time can be seen.

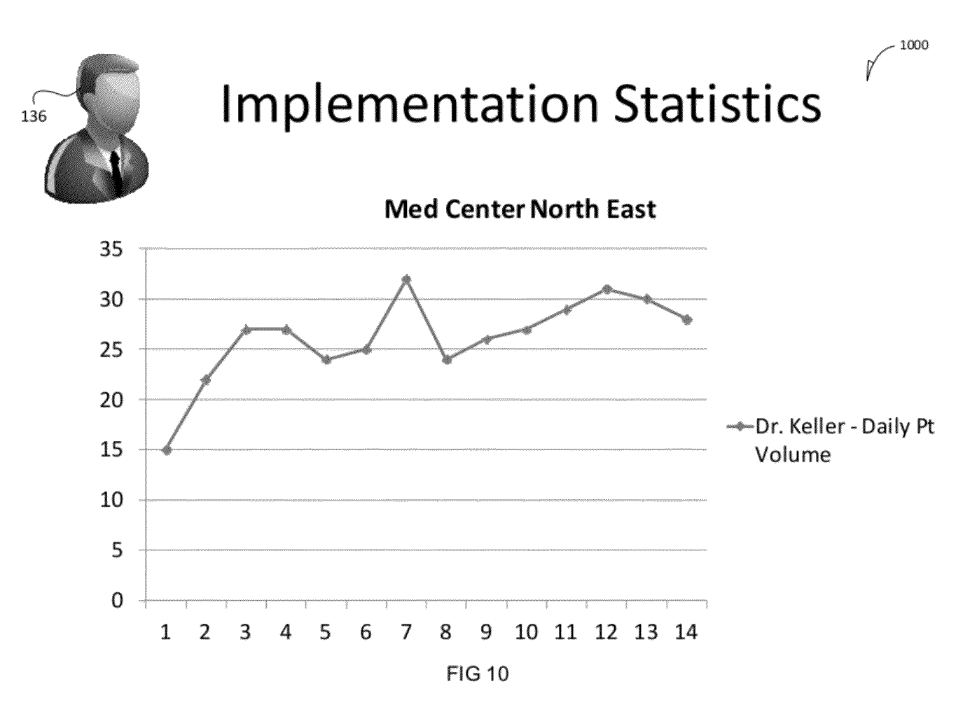

FIG. 10 is a graph 1000 showing daily patient volume (number of patients cared for during a single day) for the learner 134 (e.g., a physician), in accordance with an example embodiment. A user may click or hover a mouse over a specific graph data point to see the exact number of patients per day, which may be associated with frustration level and the acquisition or demonstration of mastery of specific skills.

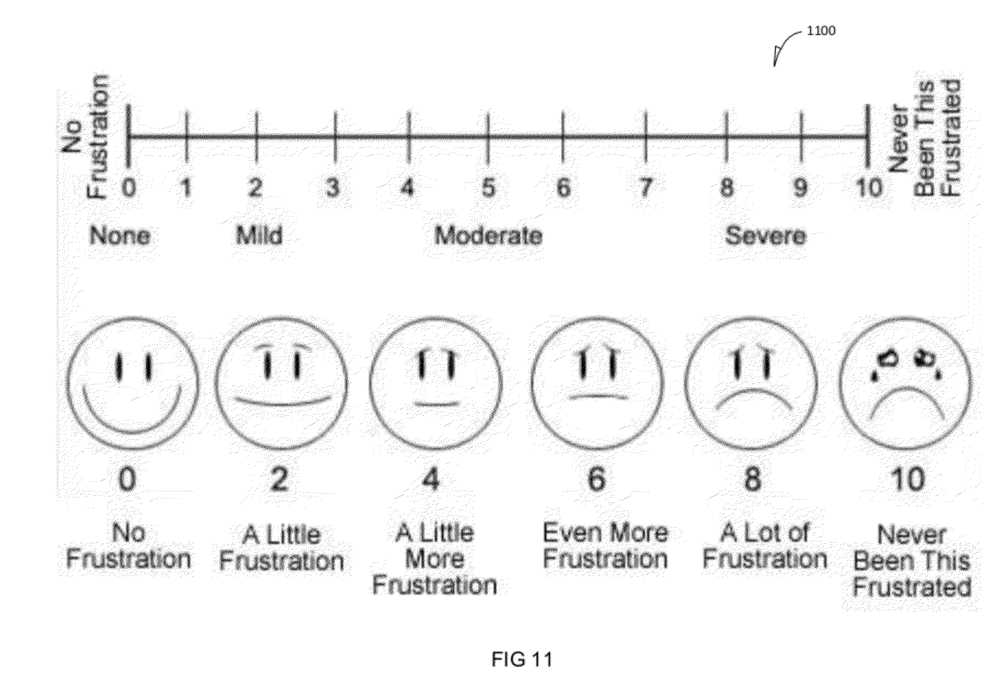

FIG. 11 is a frustration scale 1100, which may be used to select a frustration level for the learner 134, in accordance with an example embodiment. The scale is shown as a 1-10 scale to indicate frustration level. Different facial expressions can be used to represent different levels of frustration, which can be visually assessed by the support staff 142 without asking the learner 134. The support staff 142 may also determine frustration level by asking the learner 142 to use the 1-10 scale to indicate how his or her day went.

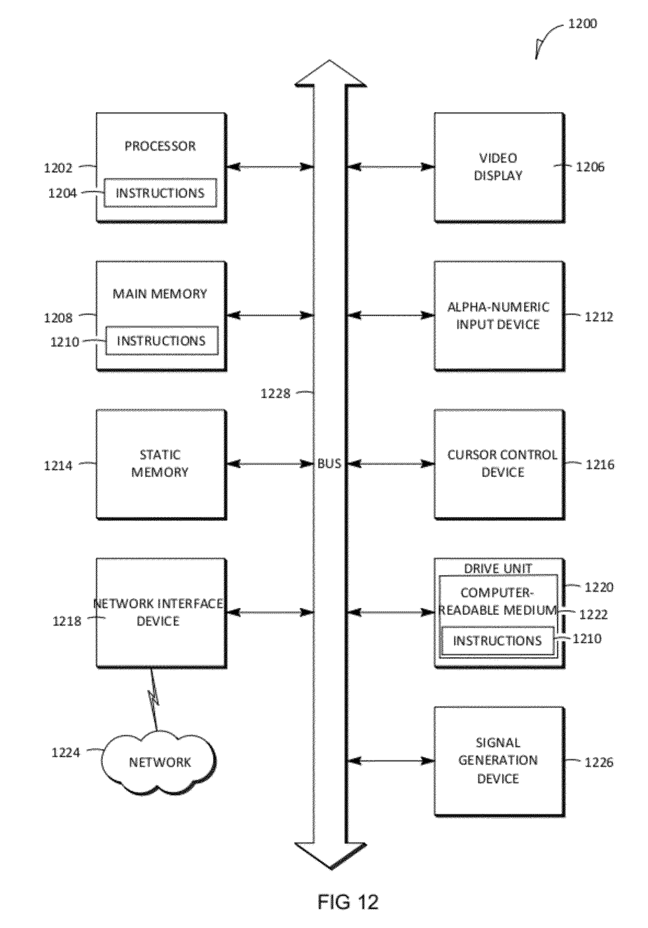

FIG. 12 is a diagrammatic representation of an example machine in the form of a computer system 1200, within which a set of instructions for causing the machine to perform any one or more of the methodologies discussed herein may be executed. In various example embodiments, the machine operates as a standalone device or may be connected (e.g., networked) to other machines. The machine may include its own internal database or be connected to an external database in order to provide substantially real time updates. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a portable music player (e.g., a portable hard drive audio device such as an Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1200 includes a processor or multiple processors 1202 (e.g., a central processing unit (CPU), a graphics processing unit (GPU), or both), a main memory 1208, and a static memory 1214, which communicate with each other via a bus 1228. The computer system 1200 may further include a video display unit 1206 (e.g., a liquid crystal display (LCD)). The computer system 1200 may also include an alphanumeric input device 1212 (e.g., a keyboard), a cursor control device 1216 (e.g., a mouse), a voice recognition or biometric verification unit (not shown), a disk drive unit 1220, a signal generation device 1226 (e.g., a speaker) and a network interface device 1218. The computer system 1200 may further include a data encryption module (not shown) to encrypt data.

The disk drive unit 1220 includes a computer-readable medium 1222 on which is stored one or more sets of instructions and data structures (e.g., instructions 1210) embodying or utilizing any one or more of the methodologies or functions described herein. The instructions 1210 may also reside, completely or at least partially, within the main memory 1208 and/or within the processors 1202 during execution thereof by the computer system 1200. The main memory 1208 and the processors 1202 may also constitute machine-readable media.

The instructions 1210 may further be transmitted or received over a network 1224 via the network interface device 1218 utilizing any one of a number of well-known transfer protocols (e.g., Hyper Text Transfer Protocol (HTTP)).

While the computer-readable medium 1222 is shown in an example embodiment to be a single medium, the term “computer-readable medium” should be taken to include a single medium or multiple media (e.g., a centralized or distributed database and/or associated caches and servers) that store the one or more sets of instructions. The term “computer-readable medium” shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term “computer-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like.

The example embodiments described herein may be implemented in an operating environment comprising software installed on a computer, in hardware, or in a combination of software and hardware.

Thus, example embodiments of systems and methods for the skill acquisition and demonstration of skill mastery have been described. Although embodiments have been described with reference to specific example embodiments, it will be evident that various modifications and changes may be made to these embodiments without departing from the broader spirit and scope of the system and method described herein. Accordingly, the specification and drawings are to be regarded in an illustrative rather than a restrictive sense.

What I claim is:

1. A computer-implemented method for management of skill acquisition and demonstration of skill mastery, the method comprising:
establishing an interface between a learner and a skill acquisition and demonstration of skill mastery system;
displaying, via the interface, one or more skills that require demonstration of mastery for a specific proficiency level by the learner;
providing training material to the learner related to a specific skill;
testing acquisition and thus mastery of the specific skill by the learner;
based on the testing, determining a skill status indicative of the acquisition of the one or more skills and thus demonstration of mastery of those skills by the learner, with each skill being associated with the skill status;
collecting statistics associated with the acquisition and thus demonstration of mastery of the one or more skills; and
providing a report of the acquisition and thus demonstration of mastery of the one or more skills.

2. The computer-implemented method of claim 1, wherein the report is provided in substantially real time across the skill acquisition and demonstration of skill mastery system.

2. The computer-implemented method of claim 1, wherein the one or more skills are predetermined based on a desired proficiency level of skill acquisition and demonstration of skill mastery.

3. The computer-implemented method of claim 1, wherein the one or more skills are related to a health information technology.

4. The computer-implemented method of claim 1, wherein the statistics associated with the acquisition of and thus demonstration of mastery of the one or more skills include a frustration level of the learner, a stress level of the learner, a time to accomplish a specific skill, and a note associated with the acquisition of and thus demonstration of mastery of the one or more skills.

5. The computer-implemented method of claim 4, wherein the learner is allowed to select the frustration level on a visual scale.

6. The computer-implemented method of claim 1, wherein the training material includes multimedia.

7. The computer-implemented method of claim 6, wherein the testing acquisition of the one or more skills by the learner includes questions related to the multimedia.

8. The computer-implemented method of claim 7, wherein correctly answering a predetermined number of the questions results in an automatic change of the status associated with the one or more skills.

9. The computer-implemented method of claim 1, further comprising recording a time stamp associated with activities of the learner and an identity of the learner.

10. The computer-implemented method of claim 1, further comprising recording a method by which the demonstration of kill mastery is assessed.

11. The computer-implemented method of claim 1, wherein the report includes a time period view, a group view, a number of skills acquired by a group of learners, a number of skills acquired by a specific learner, and a graph associated with the skill acquisition and demonstration of skill mastery.

12. The computer-implemented method of claim 11, wherein the statistics can be accessed by clicking on a point in the graph associated with the skill acquisition and demonstration of skill mastery.

13. A computer-implemented system for management of skill acquisition and demonstration of skill mastery, the system comprising:
an interface configurable between a learner and a skill acquisition and demonstration of skill mastery system;
a display module to display, via the interface, one or more skills to be acquired by a learner,
a training module to provide training material to the learner;
a testing module to test acquisition of and thus demonstration of mastery of the one or more skills by the learner;
a status module to determine, based on the testing, a status indicative of the acquisition and thus demonstration of mastery of the one or more skills by the learner;
a statistics module to collect statistics associated with the acquisition of and thus demonstration of mastery of the one or more skills; and
a report module to provide a report of the acquisition of and thus demonstration of mastery of the one or more skills.

14. The system of claim 13, wherein the interface enables a support staff to assess mastery of the one or more skills.

15. The system of claim 13, wherein the statistics associated with the acquisition of and thus demonstration of mastery of the one or more skills include a frustration level of the learner, a stress level of the learner, and notes associated with the acquisition of the one or more skills.

16. The system of claim 15, wherein the learner is allowed to select the frustration level on a visual scale.

17. The system of claim 13, wherein the training material includes multimedia.

18. The system of claim 17, wherein the testing acquisition of the one or more skills by the learner includes questions related to the multimedia.

19. The system of claim 18, wherein correctly answering a predetermined number of the questions results in an automatic change of the status associated with the one or more skills.

20. The system of claim 13, wherein the report includes a time period view, a group view, a number of skills acquired by a group of learners, a number of skills acquired by a specific learner, and a graph associated with the skill acquisition and demonstration of skill mastery.

21. The system of claim 20, wherein the statistics can be accessed by clicking on a point in the graph associated with the skill acquisition and demonstration of skill mastery, the statistics being available in substantially real time.

22. A machine-readable medium comprising instructions for improving software specifications and design using a unified document, which when implemented by one or more processors, performs the following operations:
establish an interface between a learner and a skill acquisition and demonstration of skill mastery server;
display, via the interface, one or more skills to be acquired and whose mastery should be demonstrated by the learner;
provide training material to the learner;
test mastery of the one or more skills by the learner;
based on the testing, determine a status indicative of the acquisition of the one or more skills by the learner, each skill being associated with the status;
collect statistics associated with the acquisition of and thus demonstration of mastery of the one or more skills; and
provide a report of the acquisition of the one or more skills.
